(19) United States
(12) Patent Application Publication
(10) Pub. No.: US 2011/0287747 A1
(43) Pub. Date: Nov. 24, 2011

(54) REMOTE OPERATION SYSTEM AND METHOD AND REMOTE CONTROL DEVICE

(75) Inventor: HISAO MATSUMOTO, Tokyo (JP)

(73) Assignee: Hitachi, Ltd.

(21) Appl. No.: 13/021,647

(22) Filed: Feb. 4, 2011

(30) Foreign Application Priority Data
May 21, 2010 (JP) 2010-117352

(51) Int. Cl. H04W 4/12

(52) U.S. Cl. 455/414.1

(57) ABSTRACT

To provide a remote operation method which is safe and simple for the user who does not have the enough operation knowledge on a control object apparatus installed within a house through an interactive interface. An in-house apparatus control unit has a function of sending or receiving an electronic mail to or from a portable telephone terminal and a function of making the other data communication, in which the user of the portable telephone terminal is authenticated safely according to the sender portable telephone number of the electronic mail or the ID of the sender terminal of data communication, and further an apparatus within the house is controlled by automatically judging the control contents to be requested from the contents of exchange of information with the user in an interactive form using an electronic mail or an application mounted on the portable telephone terminal.

### CLAIM OF PRIORITY

The present application claims priority from Japanese patent application JP 2010-117352 filed on May 21, 2010, the content of which is hereby incorporated by reference into this application.

### BACKGROUND OF THE INVENTION

1. Field of the Invention

The present invention relates to a remote operation system and method, and a remote control device, and more particularly to a remote operation system and method, and a remote control device for controlling a household electrical appliance, a gas utensil, or a safety device that is installed within a house, using a portable telephone terminal having a function of sending and receiving an electronic mail or a function of other data communication.

2. Description of the Related Art

In recent years, a household electrical appliance (hereinafter referred to as a network household electrical appliance), a gas water heater, and a security related apparatus (hereinafter referred to as a network connection supported apparatus) having a connection function to a network, and operable via the network from a remote site have been developed. For example, a user at a going-out destination can make access to various kinds of network connection supported apparatus at a private residence to make a recording reservation on a recorder, or confirm the locking-up, using a portable telephone terminal connectable to the internet.

In controlling these network connection supported apparatuses, a technique for providing a system for making the remote operation simply to cope with increasing number of control object apparatuses or more complicated control object function, using a portable telephone terminal having a data communication function has been developed (e.g., refer to JP-A-2005-101839).

### SUMMARY OF THE INVENTION

However, with the prior arts, though the control is simplified, it is actually presupposed that there is sufficient operation knowledge on the control object apparatus, and the operation is not simple for the users such as children or elderly unfamiliar with the operation of the control object apparatus itself.

In the light of the above-mentioned problems, an object of the invention is to allow the user unfamiliar with the operation of the apparatus or without necessary information to simply make the remote operation of the apparatus by exchange of information in an interactive form using an electronic mail from a portable telephone terminal or an application mounted on the portable telephone terminal.

In order to accomplish the above object, there is provided an in-house apparatus control unit having a function of controlling an apparatus within a house, and a function of sending and receiving a short message or multi-media message (hereinafter referred to as an electronic mail) to or from a portable telephone terminal or making the other data communication, in which the user of the portable telephone terminal is authenticated according to the portable telephone number of the electronic mail of the sender or the ID of the sender terminal of data communication, and further, if it is judged that an instruction of controlling the apparatus is received from the contents of exchange of information with the user in an interactive form using the electronic mail or an application mounted on the portable telephone terminal, the apparatus is controlled according to the instruction.

According to the first solving means of the present invention, there is provided

a remote operation system comprising:

one or more network connection supported apparatuses;

an apparatus control unit having an interactive operation interface function, comprising a control part for controlling the network connection supported apparatus, a processing part for sending and receiving a conversation sentence by an electronic mail or the other data communication, and controlling the network connection supported apparatus with the control part, a synonym dictionary DB for storing one or more synonyms for a control essential factor, and a control information DB for storing one or more pieces of necessary information for performing the control essential factor associated with the control essential factor; and

a terminal for communicating with the apparatus control unit by the electronic mail or the other data communication means;

wherein

the processing part receives the electronic mail or the data communication including a sender telephone number, a user ID or a sender terminal ID and a conversation sentence describing a desired control essential factor for controlling the network connection supported apparatus, from the terminal;

the processing part extracts the sender telephone number, the user ID or the sender terminal ID from the received electronic mail or data communication, and judges whether or not the terminal or user is capable of operating the apparatus control unit by comparing it with the sender telephone number, the user ID or the sender terminal ID of the terminal or user that is registered in advance and is capable of operating the apparatus control unit;

if it is judged that the terminal or user is capable of operating the apparatus control unit, the processing part classifies the received conversation sentence into the words by a morpheme analysis, and temporarily decides the control essential factor intended by the user from the classified words by referring to the synonym dictionary DB;

the processing part checks whether or not the enough necessary information to perform the temporarily decided control essential factor is received from the user by referring to the control information DB;

if the enough necessary information to perform the temporarily decided control essential factor is obtained, the processing part decides the control contents prescribed by the temporarily decided control essential factor and the necessary information;

on the other hand, if the enough necessary information to perform the temporarily decided control essential factor is not obtained, the processing part creates a conversation sentence for requesting the user to confirm the temporarily decided control essential factor and insufficient one or more pieces of necessary information, sends the conversation sentence to the terminal, receives again a conversation sentence of answer from the same terminal, receives the enough necessary information to perform the temporarily decided control essential factor, which is stored in the control information DB, and decides the control contents prescribed by the temporarily decided control essential factor and the necessary information; and

the processing part controls the network connection supported apparatus with the control part in accordance with the decided control contents.

According to the second solving means of the present invention, there is provided an apparatus control unit in a remote operation system comprising:

the apparatus control unit having an interactive operation interface function;

one or more network connection supported apparatuses; and

a terminal for communicating with the apparatus control unit by the electronic mail or the other data communication means,

the apparatus control unit comprising:

a control part for controlling the network connection supported apparatus,

a processing part for sending and receiving a conversation sentence by an electronic mail or the other data communication, and controlling the network connection supported apparatus with the control part,

a synonym dictionary DB for storing one or more synonyms for a control essential factor, and

a control information DB for storing one or more pieces of necessary information for performing the control essential factor associated with the control essential factor;

wherein

the processing part receives the electronic mail or the data communication including a sender telephone number, a user ID or a sender terminal ID and a conversation sentence describing a desired control essential factor for controlling the network connection supported apparatus, from the terminal;

the processing part extracts the sender telephone number, the user ID or the sender terminal ID from the received electronic mail or data communication, and judges whether or not the terminal or user is capable of operating the apparatus control unit by comparing it with the sender telephone number, the user ID or the sender terminal ID of the terminal or user that is registered in advance and is capable of operating the apparatus control unit;

if it is judged that the terminal or user is capable of operating the apparatus control unit, the processing part classifies the received conversation sentence into the words by a morpheme analysis, and temporarily decides the control essential factor intended by the user from the classified words by referring to the synonym dictionary DB;

the processing part checks whether or not the enough necessary information to perform the temporarily decided control essential factor is received from the user by referring to the control information DB;

if the enough necessary information to perform the temporarily decided control essential factor is obtained, the processing part decides the control contents prescribed by the temporarily decided control essential factor and the necessary information;

on the other hand, if the enough necessary information to perform the temporarily decided control essential factor is not obtained, the processing part creates a conversation sentence for requesting the user to confirm the temporarily decided control essential factor and insufficient one or more pieces of necessary information, sends the conversation sentence to the terminal, receives again a conversation sentence of answer from the same terminal, receives the enough necessary information to perform the temporarily decided control essential factor, which is stored in the control information DB, and decides the control contents prescribed by the temporarily decided control essential factor and the necessary information; and

the processing part controls the network connection supported apparatus with the control part in accordance with the decided control contents.

According to the third solving means of the present invention, there is provided

a remote operation method by using a remote operation system comprising:

one or more network connection supported apparatuses;

an apparatus control unit having an interactive operation interface function, comprising a control part for controlling the network connection supported apparatus, a processing part for sending and receiving a conversation sentence by an electronic mail or the other data communication, and controlling the network connection supported apparatus with the control part, a synonym dictionary DB for storing one or more synonyms for a control essential factor, and a control information DB for storing one or more pieces of necessary information for performing the control essential factor associated with the control essential factor; and

a terminal for communicating with the apparatus control unit by the electronic mail or the other data communication means;

wherein

the processing part receives the electronic mail or the data communication including a sender telephone number, a user ID or a sender terminal ID and a conversation sentence describing a desired control essential factor for controlling the network connection supported apparatus, from the terminal;

the processing part extracts the sender telephone number, the user ID or the sender terminal ID from the received electronic mail or data communication, and judges whether or not the terminal or user is capable of operating the apparatus control unit by comparing it with the sender telephone number, the user ID or the sender terminal ID of the terminal or user that is registered in advance and is capable of operating the apparatus control unit;

if it is judged that the terminal or user is capable of operating the apparatus control unit, the processing part classifies the received conversation sentence into the words by a morpheme analysis, and temporarily decides the control essential factor intended by the user from the classified words by referring to the synonym dictionary DB;

the processing part checks whether or not the enough necessary information to perform the temporarily decided control essential factor is received from the user by referring to the control information DB;

if the enough necessary information to perform the temporarily decided control essential factor is obtained, the processing part decides the control contents prescribed by the temporarily decided control essential factor and the necessary information;

on the other hand, if the enough necessary information to perform the temporarily decided control essential factor is not obtained, the processing part creates a conversation sentence for requesting the user to confirm the temporarily decided control essential factor and insufficient one or more pieces of necessary information, sends the conversation sentence to the terminal, receives again a conversation sentence of answer from the same terminal, receives the enough necessary information to perform the temporarily decided control essential factor, which is stored in the control information DB, and decides the control contents prescribed by the temporarily decided control essential factor and the necessary information; and

the processing part controls the network connection supported apparatus with the control part in accordance the decided control contents.

With the invention, it is possible to make the user authentication simply and safely by using an electronic mail service or a data communication service of a portable telephone entrepreneur with relatively lower possibility of illegal use such as disguising, and further using the sender portable telephone number or the sender ID of data communication for the apparatus installed within the house. Also, the user unfamiliar with the operation of the apparatus or without necessary information can simply make the remote operation of the apparatus by exchange of information in an interactive form using the electronic mail from the portable telephone terminal, or the application mounted on the portable telephone terminal.

### BRIEF DESCRIPTION OF THE DRAWINGS

FIG. 1 is a configuration view of a remote operation system according to an embodiment of the present invention.

FIG. 2 is an explanatory view showing one example of performing the remote control through an interactive interface according to the embodiment.

FIG. 3A is a flowchart (1) showing one example of the operation flow of a specific process in an in-house apparatus control unit.

FIG. 3B is a flowchart (2) showing one example of the operation flow of the specific process in the in-house apparatus control unit.

FIG. 4 is a block diagram for a language processing function in the in-house apparatus control unit.

FIG. 5 is a view showing an example of a control information DB according to the embodiment.

FIG. 6 is a sequence chart of performing the remote control through the interactive interface.

FIG. 7 is a view showing an example of a synonym dictionary DB according to the embodiment.

### DETAILED DESCRIPTION OF THE PREFERRED EMBODIMENTS

The present invention will be described below in connection with the embodiments, but the following embodiments do not limit the invention as defined in the claims, and all the combinations of features as described in the embodiments are not requisite to solving means of the invention.

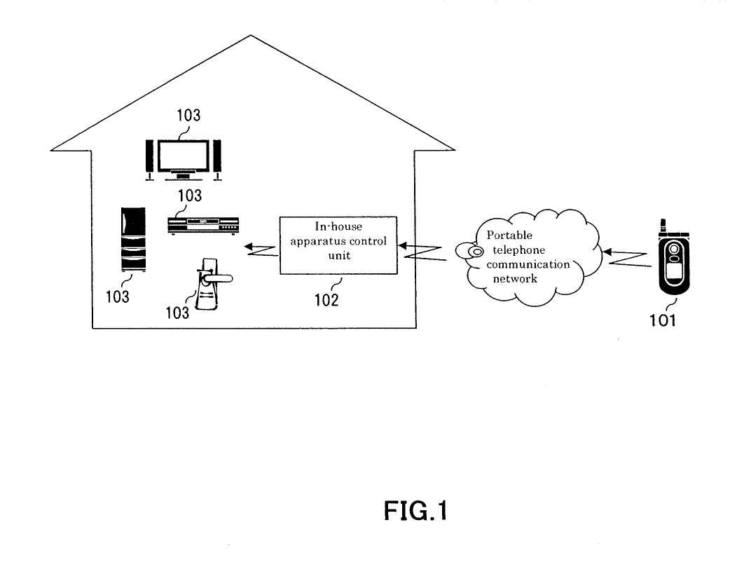

FIG. 1 is a configuration view for explaining an overview of a remote operation system according to an embodiment of the invention. In FIG. 1, a portable telephone terminal 101 communicates with an in-house apparatus control unit 102 by an electronic mail or other data communication means. The in-house apparatus control unit 102 has a function of controlling a network connection supported apparatus 103 within a house as well. Examples of the network connection supported apparatus 103 may include a network household electric appliance such as a TV or a recorder, a bath, a door lock, a gas water heater, and a security related apparatus.

Next, a process for controlling the apparatus 103 within the house at the portable telephone terminal 101 will be described below. First of all, the portable telephone terminal 101 makes an inquiry to the in-house apparatus control unit 102 via a portable telephone network. On this occasion, the in-house apparatus control unit 102 judges whether the user of the portable telephone terminal 101 can operate the in-house apparatus control unit 102, using a sender portable telephone number of electronic mail or a sender ID of data communication, and only if the user of the portable telephone terminal 101 can operate it, the following communication is made, so that the user of the portable telephone terminal 101 can remotely operate the in-house apparatus control unit 102.

The user of the portable telephone terminal 101 capable of remotely operating the in-house apparatus control unit 102 can input a control information into the in-house apparatus control unit 102 through conversation by exchange of information in an interactive form sending or receiving an electronic mail, or using an application mounted on the portable telephone terminal 101, whereby the in-house apparatus control unit 102 can control the apparatus 103 within the house, based on the inputted control information.

Next, a process for the in-house apparatus control unit 102 through the conversation by exchange of information in an interactive form sending or receiving the electronic mail or using the application mounted on the portable telephone terminal 101, which is made between the portable telephone terminal 101 and the in-house apparatus control unit 102, will be outlined below.

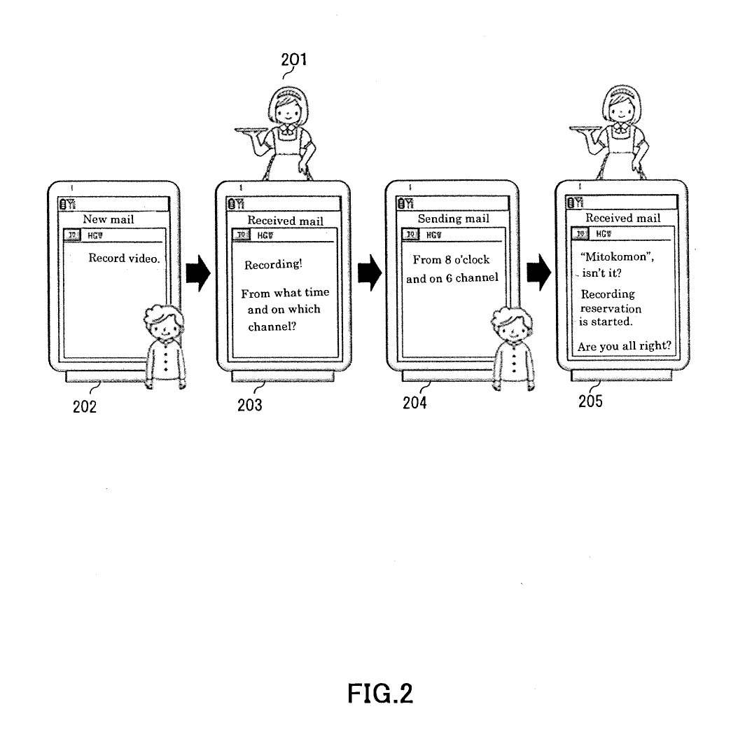

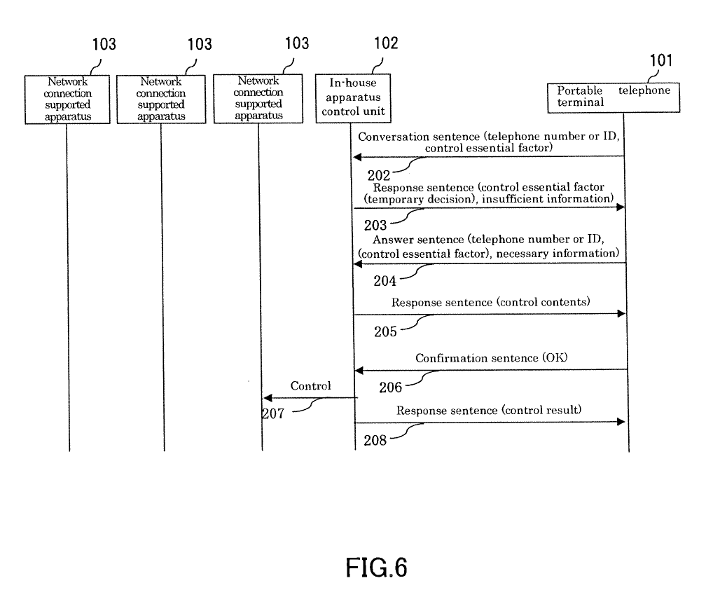

FIG. 2 is an explanatory view showing one example of communication between the portable telephone terminal 101 and the in-house apparatus control unit 102 according to the embodiment. Also, FIG. 6 is a sequence chart of performing the remote control through the interactive interface. The reference numerals of FIGS. 2 and 6 correspond to each other.

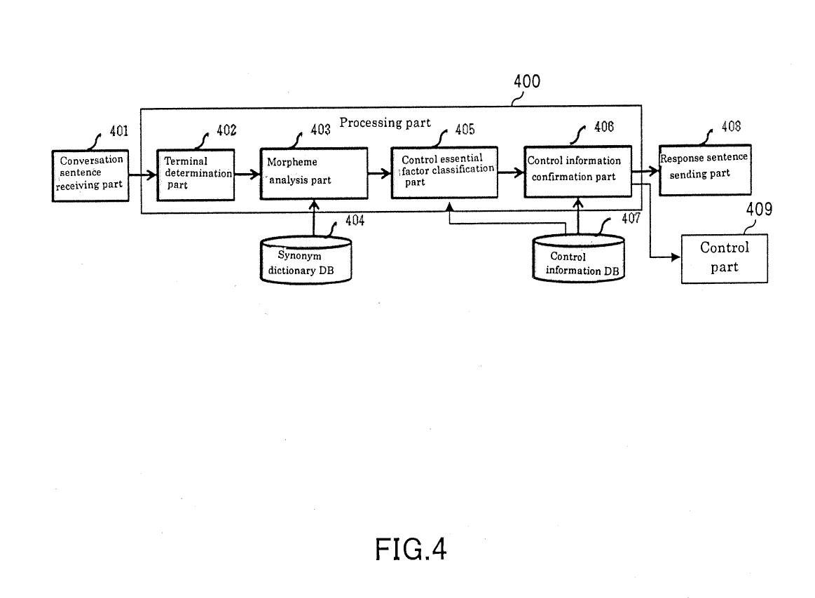

In FIGS. 2 and 6, the user converses the outline of essence of control with the in-house apparatus control unit 102 by an electronic mail function of the portable telephone terminal 101 or an application mounted on the portable telephone terminal 101. In this example, with an image that there is a maidservant agent 201 personified within the in-house apparatus control unit 102, the user can converse with the in-house apparatus control unit 102 with more feeling of familiarity. The in-house apparatus control unit 102 makes a language processing for a conversation sentence 202 received by an electronic mail or other data communication means from the user, as shown in FIG. 4 as will be described later, and judges the essence intended by the user and the information requiring confirmation. For example, in FIG. 2, the words of “video” and “record” in the first conversation are extracted, and from these words, it is judged that the user intends to record on a recorder, whereby it is necessary that the information on the recording time and recording channel are checked to perform the control. Hence, the in-house apparatus control unit 102 sends a response sentence 203 for making a confirmation of understanding that there is a recording request with the recorder and a confirmation of additional information necessary for control execution to the portable telephone terminal 101. On the contrary, the user sends an answer sentence 204 for the recording time and recording channel. The in-house apparatus control unit 102 judges the recording time and recording channel intended by the user by making the language processing again, properly inferring a program name from an electronic program guide information acquired in advance, and sends again a response sentence 205 for making confirmation to the user. In this way, the control contents are finally decided by repeating an operation of confirming the necessary information at the same time of investigating the control contents intended by the user in the interactive form. The control contents can be prescribed by the decided control essential factor, or both the control essential factor and the necessary information. And after the user confirms the control contents (206), the in-house apparatus control unit 102 controls a predetermined network connection supported apparatus 103 in accordance with the control contents (207). Next, the in-house apparatus control unit 102 sends the control result to the user (208).

Next, the specific processing contents of the in-house apparatus control unit 102 will be described below.

FIG. 4 is a block diagram for a language processing function in the in-house apparatus control unit 102.

The in-house apparatus control unit 102 comprises a processing part 400, a conversation sentence receiving part 401, a synonym dictionary DB 404, a control information DB 407, a response sentence sending part 408, and a control part 409. Also, the processing part 400 has a terminal determination part 402, a morpheme analysis part 403, a control essential factor classification part 405, and a control information confirmation part 406.

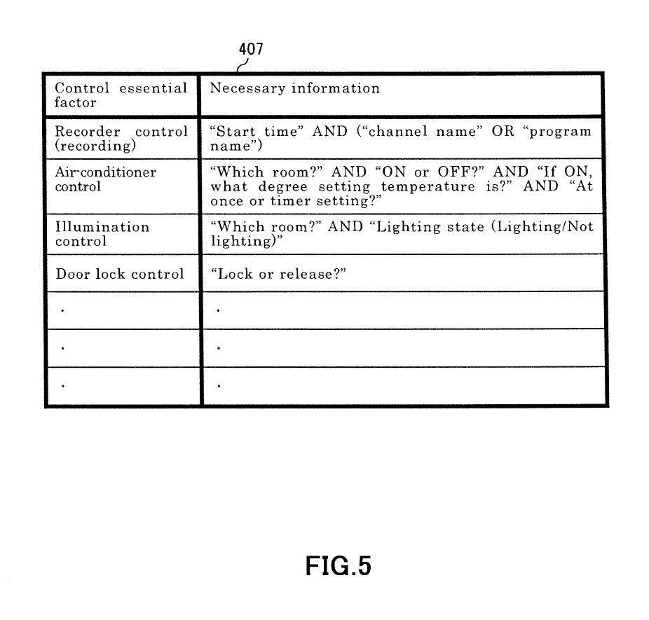

FIG. 5 is a view showing an example of the control information DB 407.

The control information DB 407 stores necessary information (required information) for performing the control essential factor, associated with the control essential factor for controlling each network connection supported apparatus.

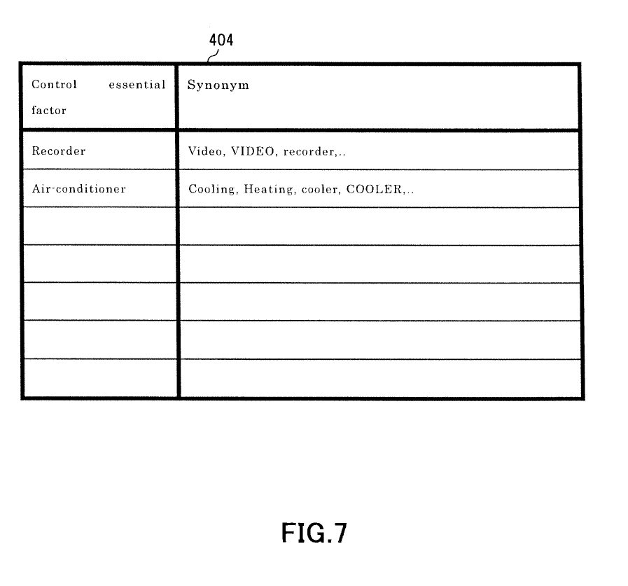

FIG. 7 is an explanatory view showing an example of the synonym dictionary DB 404. The synonym dictionary DB 404 stores synonyms for each control essential factor stored in the control information DB 407. The synonym dictionary DB 404 may further store synonyms for necessary information.

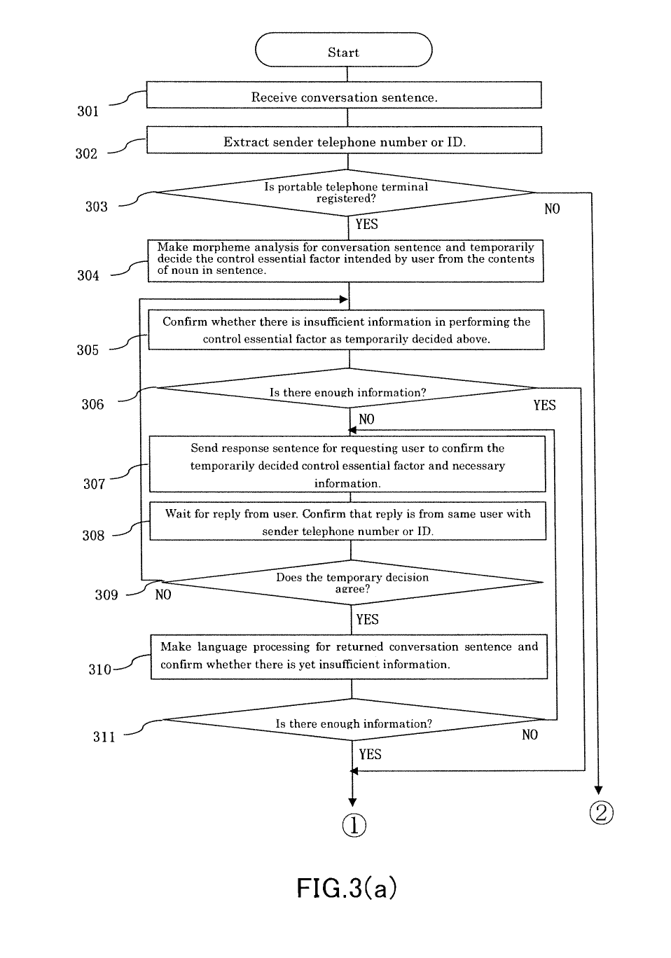

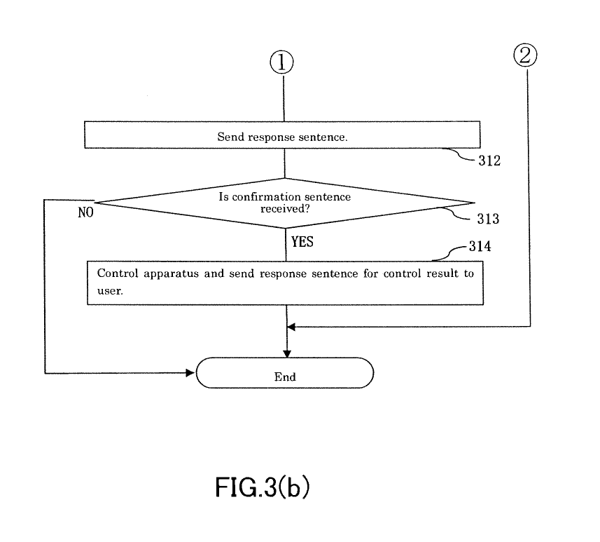

FIGS. 3A and 3B are flowcharts showing one example of the operation flow of a specific process in the in-house apparatus control unit 102.

First of all, if the conversation sentence receiving part 401 receives a conversation sentence from the portable telephone terminal 101 (301), and the terminal determination part 402 extracts the sender telephone number or ID of the portable telephone terminal 101 for the received conversation sentence (302), and judges whether or not the user of the portable telephone terminal 101 can operate the in-house apparatus control unit 102 (303). For example, the terminal determination part 402 can make this judgment by pre-storing the operable sender telephone number or ID of the portable telephone terminal 101, and comparing it with the received sender telephone number or ID of the portable telephone terminal 101. And if the terminal determination part 402 judges that the user of the portable telephone terminal 101 can operate the in-house apparatus control unit 102 (Yes at 303), the process is transferred to the morpheme analysis part 403. If the terminal determination part 402 judges that the user of the portable telephone terminal 101 can not operate the in-house apparatus control unit 102 (No at 303), the process is once ended there.

Next, the control essential factor classification part 405 temporarily decides the control essential factor intended by the user from among the words classified into noun in the morpheme analysis performed in the morpheme analysis part 403 by referring the synonym dictionary DB 404, based on the conversation sentence (304). (For example, if the noun in the sentence is “recorder”, the control essential factor is temporarily decided as “recorder control”, and if the noun in the sentence is “air-conditioner”, the control essential factor is temporarily decided as “air-conditioner cooling and heating”.) Further, the control information confirmation part 406 checks whether or not there is enough information to perform the temporarily decided control essential factor by referring to the control information DB 407 (305). And if there is enough information to perform it (Yes at 306), the temporarily decided control essential factor is directly performed and a response sentence for the control result is sent to the user (312).

Also, the control information confirmation part 406 judges that there is not enough information to perform the temporarily decided control essential factor (No at 306), the response sentence sending part 408 creates and sends a response sentence for confirming the temporarily decided control essential factor and insufficient information to the user (307). Thereafter, if the conversation sentence receiving part 401 receives again an answer sentence from the same user (308), it is confirmed that the answer sentence does not negate the temporary decision of the control essential factor (Yes at 309), and the control information confirmation part 406 checks again whether or not there is enough information to perform the control essential factor by further making the language processing for this answer sentence (310). Herein, if there is yet less information (No at 311), the response sentence sending part 408 sends a response sentence for confirming the insufficient information to the user (307), in which this cycle is repeated until there is no insufficient information.

If the temporarily decided control essential factor is not desired for the response sentence at step 307, the user sends an answer sentence to the effect that the temporary decision does not agree (308). If this answer sentence is received (No at 309), the operation returns to step 305.

On the other hand, if there is enough information to perform the temporarily decided control essential factor (Yes at 311), the response sentence sending part 408 sends a response sentence for the control contents (that can include the control essential factor and the necessary information) to the user (312). If a confirmation sentence indicating that the control contents are to be performed is received from the user, the temporarily decided control essential factor is directly performed, and a response sentence for the control result is sent to the user. On the other hand, if the confirmation sentence can not be received for a certain period of time, or the confirmation sentence indicating that the control contents are not to be performed is received, the process is ended. In the confirmation sentence, “OK”, “execute”, “YES”, “NO”, or “Not execute”, for example, may be used. Also, the steps 312 and 313 may be omitted.

Next, the language processing that is performed in creating the response sentence from the contents of the conversation sentence in the in-house apparatus control unit 102 will be described below. First of all, the in-house apparatus control unit 102 receives a conversation sentence from the portable telephone terminal 101, and judges that the conversation sentence is originated from the user of the portable telephone terminal 101 capable of operating the in-house apparatus control unit 102, in which this conversation sentence is divided into rows of morphemes in the morpheme analysis part 403, and each part of speech is discriminated. Also, the synonym dictionary DB 404 pre-stores a list of synonyms for each word included in the control essential factor (or both the control essential factor and the necessary information) of the control information DB 407. And the morpheme analysis part 403 absorbs dispersion in the meaning of words for the classified morpheme in the synonym dictionary DB 404 and converts them into the word suitable for later processing. (For example, the nouns such as “video”, “VIDEO” and “recorder” are converted into “recorder”.) Thereafter, the control essential factor classification part 405 determines the control essential factor of object by comparing the word converted in the morpheme analysis part 403 with the control essential factor of the control information DB 407. (For example, if the word of noun “recorder” appears from the result of the morpheme analysis, the control essential factor is determined as “recorder control”. Also, if the word of noun “air-conditioner” appears from the result of the morpheme analysis, the control essential factor is determined as “air-conditioner control”.) Next, the control information confirmation part 406 investigates the information necessary for control from the control information DB 407, determines the known information and the unknown information, and creates a response sentence for requesting the user to confirm the unknown information. (For example, in the case of “recorder control”, the information such as “start time”, “channel name” or “program name” is required, and if the information is unknown, the confirmation to the user is required. Also, in the case of “air-conditioner control”, the information such as “which room?”, “ON or OFF?”, “if ON, at what degree is the setting temperature?”, and “at once or timer setting?” is required, and if the information is unknown, the confirmation to the user is required.) The user may send only the control essential factor, or both the control essential factor and the necessary information. Also, if the synonym dictionary DB 404 stores a synonym of necessary information, the processing part 400 can absorb dispersion in the meaning of words in the classified morpheme for the necessary information and convert them into the work suitable for later processing.

Through the above language processing, the essence intended by the user and the information requiring confirmation can be judged.

Though the sender telephone number or ID of the portable telephone terminal is used for authentication of the terminal or user in the above explanation, the proper identification information such as user ID or terminal ID may be additionally used. Also, besides the portable telephone terminal, the proper wireless or wire terminal such as PDA or PC may be used. Further, the apparatus not only within the house but also outside the house can be controlled.

What is claimed is:

1. A remote operation system comprising:
one or more network connection supported apparatuses;
an apparatus control unit having an interactive operation interface function, comprising a control part for controlling the network connection supported apparatus, a processing part for sending and receiving a conversation sentence by an electronic mail or the other data communication, and controlling the network connection supported apparatus with the control part, a synonym dictionary DB for storing one or more synonyms fora control essential factor, and a control information DB for storing one or more pieces of necessary information for performing the control essential factor associated with the control essential factor; and
a terminal for communicating with the apparatus control unit by the electronic mail or the other data communication means;
wherein
the processing part receives the electronic mail or the data communication including a sender telephone number, a user ID or a sender terminal ID and a conversation sentence describing a desired control essential factor for controlling the network connection supported apparatus, from the terminal;
the processing part extracts the sender telephone number, the user ID or the sender terminal ID from the received electronic mail or data communication, and judges whether or not the terminal or user is capable of operating the apparatus control unit by comparing it with the sender telephone number, the user ID or the sender terminal ID of the terminal or user that is registered in advance and is capable of operating the apparatus control unit;
if it is judged that the terminal or user is capable of operating the apparatus control unit, the processing part classifies the received conversation sentence into the words by a morpheme analysis, and temporarily decides the control essential factor intended by the user from the classified words by referring to the synonym dictionary DB;
the processing part checks whether or not the enough necessary information to perform the temporarily decided control essential factor is received from the user by referring to the control information DB;
if the enough necessary information to perform the temporarily decided control essential factor is obtained, the processing part decides the control contents prescribed by the temporarily decided control essential factor and the necessary information;
on the other hand, if the enough necessary information to perform the temporarily decided control essential factor is not obtained, the processing part creates a conversation sentence for requesting the user to confirm the temporarily decided control essential factor and insufficient one or more pieces of necessary information, sends the conversation sentence to the terminal, receives again a conversation sentence of answer from the same terminal, receives the enough necessary information to perform the temporarily decided control essential factor, which is stored in the control information DB, and decides the control contents prescribed by the temporarily decided control essential factor and the necessary information; and
the processing part controls the network connection supported apparatus with the control part in accordance with the decided control contents.

2. The remote operation system according to claim 1, wherein
the processing part sends a conversation sentence for confirming to make the control in accordance with the control contents including the control essential factor and the necessary information, if the control essential factor is temporarily decided, and
the processing part, upon receiving a conversation sentence indicating that the control contents are confirmed from the terminal, controls the network connection apparatus in accordance with the control contents.

3. The remote operation system according to claim 1, wherein
if the processing part confirms that the conversation sentence answered from the terminal does not negate the temporary decision of the control essential factor, the processing part further repeats the following processing until there is no insufficient necessary information,
in which the processing part makes a language processing for the answered conversation sentence to reconfirm that there is the enough necessary information to perform the control essential factor, and if the necessary information is yet insufficient, the processing part sends a conversation sentence for requesting the insufficient necessary information to the user.

4. The remote operation system according to claim 1, wherein
the processing part controls the network connection apparatus in accordance with the control contents, and sends a conversation sentence of the control result to the terminal.

5. The remote operation system according to claim 1, wherein
the processing part further comprises:
a terminal determination part for authenticating the terminal or user capable of operating the network connection supported apparatus,
a morpheme analysis part for dividing the conversation sentence received from the terminal into rows of morphemes, discriminating each word, by referring to the synonym dictionary DB, absorbing a dispersion in the meaning of words and converting them into the word that applies to the control essential factor and/or the necessary information,
a control essential factor classification part for obtaining the control essential factor by referring to the control information DB, and
a control information confirmation part for investigating the necessary information corresponding to the obtained control essential factor by referring to the control information DB, and requesting the user to confirm the necessary information that is not received,
wherein the processing part judges the control contents prescribed by the control essential factor intended by the user and the necessary information.

6. The remote operation system according to claim 1, wherein
the in-house apparatus control unit further comprises a conversation sentence receiving part and a response sentence sending part for communicating the conversation sentence with the terminal by the electronic mail or other data communication.

7. An apparatus control unit in a remote operation system comprising:
the apparatus control unit having an interactive operation interface function;
one or more network connection supported apparatuses; and
a terminal for communicating with the apparatus control unit by the electronic mail or the other data communication means,
the apparatus control unit comprising:
a control part for controlling the network connection supported apparatus,
a processing part for sending and receiving a conversation sentence by an electronic mail or the other data communication, and controlling the network connection supported apparatus with the control part,
a synonym dictionary DB for storing one or more synonyms for a control essential factor, and
a control information DB for storing one or more pieces of necessary information for performing the control essential factor associated with the control essential factor;
wherein
the processing part receives the electronic mail or the data communication including a sender telephone number, a user ID or a sender terminal ID and a conversation sentence describing a desired control essential factor for controlling the network connection supported apparatus, from the terminal;
the processing part extracts the sender telephone number, the user ID or the sender terminal ID from the received electronic mail or data communication, and judges whether or not the terminal or user is capable of operating the apparatus control unit by comparing it with the sender telephone number, the user ID or the sender terminal ID of the terminal or user that is registered in advance and is capable of operating the apparatus control unit;
if it is judged that the terminal or user is capable of operating the apparatus control unit, the processing part classifies the received conversation sentence into the words by a morpheme analysis, and temporarily decides the control essential factor intended by the user from the classified words by referring to the synonym dictionary DB;
the processing part checks whether or not the enough necessary information to perform the temporarily decided control essential factor is received from the user by referring to the control information DB;
if the enough necessary information to perform the temporarily decided control essential factor is obtained, the processing part decides the control contents prescribed by the temporarily decided control essential factor and the necessary information;
on the other hand, if the enough necessary information to perform the temporarily decided control essential factor is not obtained, the processing part creates a conversation sentence for requesting the user to confirm the temporarily decided control essential factor and insufficient one or more pieces of necessary information, sends the conversation sentence to the terminal, receives again a conversation sentence of answer from the same terminal, receives the enough necessary information to perform the temporarily decided control essential factor, which is stored in the control information DB, and decides the control contents prescribed by the temporarily decided control essential factor and the necessary information; and
the processing part controls the network connection supported apparatus with the control part in accordance with the decided control contents.

8. A remote operation method by using a remote operation system comprising:
one or more network connection supported apparatuses;
an apparatus control unit having an interactive operation interface function, comprising a control part for controlling the network connection supported apparatus, a processing part for sending and receiving a conversation sentence by an electronic mail or the other data communication, and controlling the network connection supported apparatus with the control part, a synonym dictionary DB for storing one or more synonyms for a control essential factor, and a control information DB for storing one or more pieces of necessary information for performing the control essential factor associated with the control essential factor; and
a terminal for communicating with the apparatus control unit by the electronic mail or the other data communication means;
wherein
the processing part receives the electronic mail or the data communication including a sender telephone number, a user ID or a sender terminal ID and a conversation sentence describing a desired control essential factor for controlling the network connection supported apparatus, from the terminal;
the processing part extracts the sender telephone number, the user ID or the sender terminal ID from the received electronic mail or data communication, and judges whether or not the terminal or user is capable of operating the apparatus control unit by comparing it with the sender telephone number, the user ID or the sender terminal ID of the terminal or user that is registered in advance and is capable of operating the apparatus control unit;
if it is judged that the terminal or user is capable of operating the apparatus control unit, the processing part classifies the received conversation sentence into the words by a morpheme analysis, and temporarily decides the control essential factor intended by the user from the classified words by referring to the synonym dictionary DB;
the processing part checks whether or not the enough necessary information to perform the temporarily decided control essential factor is received from the user by referring to the control information DB;
if the enough necessary information to perform the temporarily decided control essential factor is obtained, the processing part decides the control contents prescribed by the temporarily decided control essential factor and the necessary information;
on the other hand, if the enough necessary information to perform the temporarily decided control essential factor is not obtained, the processing part creates a conversation sentence for requesting the user to confirm the temporarily decided control essential factor and insufficient one or more pieces of necessary information, sends the conversation sentence to the terminal, receives again a conversation sentence of answer from the same terminal, receives the enough necessary information to perform the temporarily decided control essential factor, which is stored in the control information DB, and decides the control contents prescribed by the temporarily decided control essential factor and the necessary information; and
the processing part controls the network connection supported apparatus with the control part in accordance with the decided control contents.

9. The remote operation method according to claim 8, wherein
the user sends or receives the conversation sentence for control with the apparatus control unit by an electronic mail function of the terminal or an application contained in the terminal.

10. The remote operation method according to claim 8, wherein
a personified maidservant, steward, or maid agent exists inside the apparatus control unit to enable the user at the terminal to converse with the apparatus control unit.

11. The apparatus control unit according to claim 7, wherein
the processing part sends a conversation sentence for confirming to make the control in accordance with the control contents including the control essential factor and the necessary information, if the control essential factor is temporarily decided, and
the processing part, upon receiving a conversation sentence indicating that the control contents are confirmed from the terminal, controls the network connection apparatus in accordance with the control contents.

12. The apparatus control unit according to claim 7, wherein
if the processing part confirms that the conversation sentence answered from the terminal does not negate the temporary decision of the control essential factor, the processing part further repeats the following processing until there is no insufficient necessary information,
in which the processing part makes a language processing for the answered conversation sentence to reconfirm that there is the enough necessary information to perform the control essential factor, and if the necessary information is yet insufficient, the processing part sends a conversation sentence for requesting the insufficient necessary information to the user.

13. The apparatus control unit according to claim 7, wherein
the processing part controls the network connection apparatus in accordance with the control contents, and sends a conversation sentence of the control result to the terminal.

14. The apparatus control unit according to claim 7, wherein
the processing part further comprises:
a terminal determination part for authenticating the terminal or user capable of operating the network connection supported apparatus,
a morpheme analysis part for dividing the conversation sentence received from the terminal into rows of morphemes, discriminating each word, by referring to the synonym dictionary DB, absorbing a dispersion in the meaning of words and converting them into the word that applies to the control essential factor and/or the necessary information,
a control essential factor classification part for obtaining the control essential factor by referring to the control information DB, and
a control information confirmation part for investigating the necessary information corresponding to the obtained control essential factor by referring to the control information DB, and requesting the user to confirm the necessary information that is not received,
wherein the processing part judges the control contents prescribed by the control essential factor intended by the user and the necessary information.

15. The apparatus control unit according to claim 7, wherein
the in-house apparatus control unit further comprises a conversation sentence receiving part and a response sentence sending part for communicating the conversation sentence with the terminal by the electronic mail or other data communication.

16. The remote operation method according to claim 8, wherein
the processing part sends a conversation sentence for confirming to make the control in accordance with the control contents including the control essential factor and the necessary information, if the control essential factor is temporarily decided, and
the processing part, upon receiving a conversation sentence indicating that the control contents are confirmed from the terminal, controls the network connection apparatus in accordance with the control contents.

17. The remote operation method according to claim 8, wherein
if the processing part confirms that the conversation sentence answered from the terminal does not negate the temporary decision of the control essential factor, the processing part further repeats the following processing until there is no insufficient necessary information,
in which the processing part makes a language processing for the answered conversation sentence to reconfirm that there is the enough necessary information to perform the control essential factor, and if the necessary information is yet insufficient, the processing part sends a conversation sentence for requesting the insufficient necessary information to the user.

18. The remote operation method according to claim 8, wherein
the processing part controls the network connection apparatus in accordance with the control contents, and sends a conversation sentence of the control result to the terminal.

19. The remote operation method according to claim 8, wherein
the processing part further comprises:
a terminal determination part for authenticating the terminal or user capable of operating the network connection supported apparatus,
a morpheme analysis part for dividing the conversation sentence received from the terminal into rows of morphemes, discriminating each word, by referring to the synonym dictionary DB, absorbing a dispersion in the meaning of words and converting them into the word that applies to the control essential factor and/or the necessary information,
a control essential factor classification part for obtaining the control essential factor by referring to the control information DB, and
a control information confirmation part for investigating the necessary information corresponding to the obtained control essential factor by referring to the control information DB, and requesting the user to confirm the necessary information that is not received,
wherein the processing part judges the control contents prescribed by the control essential factor intended by the user and the necessary information.

20. The remote operation method according to claim 8, wherein
the in-house apparatus control unit further comprises a conversation sentence receiving part and a response sentence sending part for communicating the conversation sentence with the terminal by the electronic mail or other data communication.
